(19) United States
(12) Patent Application Publication
(10) Pub. No.: US 2023/0061853 A1
(43) Pub. Date: Mar. 2, 2023

(54) REVERSE DIRECTIONAL THRUST DEVICE BY BIDIRECTIONAL TRANSLATIVE MOVEMENT

(71) Applicant: Taoufik HICHAM, Marrakech (MA)

(72) Inventor: Taoufik HICHAM, Marrakech (MA)

(21) Appl. No.: 17/578,514

(22) Filed: Jan. 19, 2022

(30) Foreign Application Priority Data
Aug. 24, 2021 (MA) 54024

(51) Int. Cl. F03H 99/00; B64G 1/28

(52) U.S. Cl. CPC F03H 99/00; B64G 1/283

(57) ABSTRACT

A reverse directional thrust device by a bidirectional translative movement is provided. The reverse directional thrust device is a thruster, formed by a drive motor, a magnetic reversing mechanism, and a system within a hermetic frame. The system allows a thrust to forward a sense of direction and to reverse the thrust towards an opposite sense of direction, and starting from an expulsion of compressed air, from an interaction with a magnetic field allowing the bidirectional translative movements of components rotary, wherein two translating impulse discs perforated with curved holes and fixed to a threaded axis of rotation, and a toothed disc interposed between the two translating impulse discs. The drive motor and the magnetic reversing mechanism do not fall within a scope of the reverse directional thrust device.

### CROSS REFERENCE TO THE RELATED APPLICATIONS

This application is based upon and claims priority to Moroccan Patent Application No. 54024 filed on Aug. 24, 2021, the entire contents of which are incorporated herein by reference.

### TECHNICAL FIELD

The reverse directional thrust device by bidirectional translative movement, intended to produce a thrust towards a sense of direction, and to reverse this thrust towards the opposite sense of direction. This device is formed by a drive motor, a magnetic reversing mechanism and a system within a hermetic frame.

(Drive motor (M), and magnetic reversing mechanism do not fall within the scope of the present invention).

### BACKGROUND

The patent of invention entitled “Sequential impulse thruster” is filed by me (Mr. HICHAM TAOUFIK) at the Moroccan office of industrial and commercial property (OMPIC) on Dec. 3, 2019 under No. 47560 and at WIPO-Geneva on Oct. 20, 2020 under No. PCT/MA2020/000009. However, the present invention provides a new bidirectional translative movement system, allowing not only a thrust but also reverse thrust and the reversal of the sense of direction.

Nowadays, the technology has not presented a system composed of a toothed disc, perforated with holes, and interposed between two translative pulse discs, fixed to a threaded axis of rotation, whose bidirectional translative movement within a hermetic frame with compressed air, allows to produce a thrust towards a sense of direction and to reverse this thrust towards the opposite sense of direction, and this in an atmospheric space and/or outside the Earth atmosphere.

### SUMMARY

The reverse directional thrust device by bidirectional translative movement, invented to reduce the energy dependence relating to the movement of our machines, it is a device that represents a new alternative system.

Brief differences in features between a sequential impulse thruster and the present invention, concerning the reverse directional thrust device by bidirectional translative movement:
The expulsion set of a sequential impulse thruster is formed by two units, namely, a perforated disc of several holes and a sequence propeller or a single sequence disc, to the contrary the expulsion set of a reverse directional thrust device by bidirectional translative movement must be formed by three units, namely a toothed disc perforated with straight holes and two translative pulse discs, perforated with curved holes.
The expulsion set of a sequential impulse thruster, allows a single sense of direction. Instead, the expulsion set of the reverse directional thrust device by bidirectional translative movement, allows a sense of direction and the reversal of this sense of direction.
The rotary motion components of a sequential impulse thruster do not have a bidirectional translative movement, unlike those belonging to the reverse directional thrust device by bidirectional translative movement, which must have said translative movement bidirectional.
The flanged and threaded axis of a sequential impulse thruster has two coaxial outputs fixed to ball bearings, which allow a fluidity of rotation to said axis. However, the threaded axis of rotation of a reverse directional thrust device by bidirectional translative movement has two coaxial outputs supported by linear bearings allowing rotation and bidirectional translative movement to this threaded axis of rotation to which two sequence discs are fixed.
The expulsion of compressed air through the holes of the perforated disc of several holes of a sequential impulse thruster is activated by a single face of the perforated disc of several holes. On the other side, the expulsion of compressed air through the holes of the toothed disc of a reverse directional thrust device by bidirectional translative movement can be activated by one face, as it can be activated by the other face of its toothed disc.

The thrust of a sequential impulse thruster is engaged automatically when starting by the drive motor. On the other side, the thrust of a reverse directional thrust device by bidirectional translative movement cannot be activated by the system as long as it is in the neutral position.

### BRIEF DESCRIPTION OF THE DRAWINGS

FIG. 1 is the illustration of a device whose system is in neutral position (formed by a single set of expulsion).

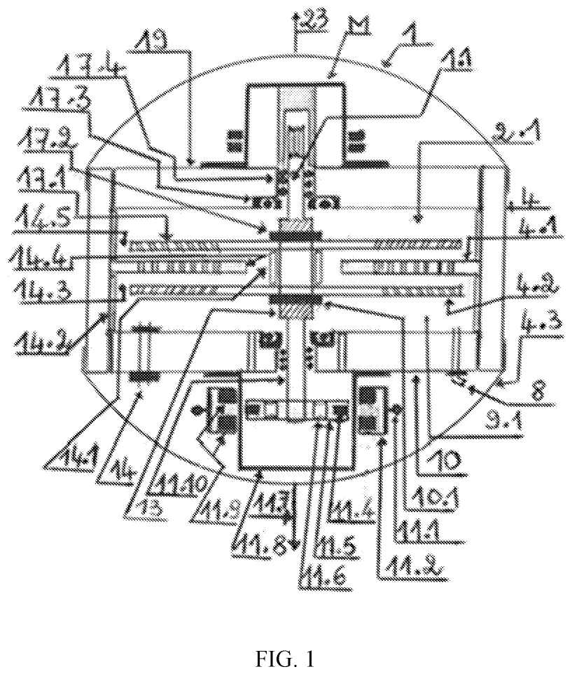

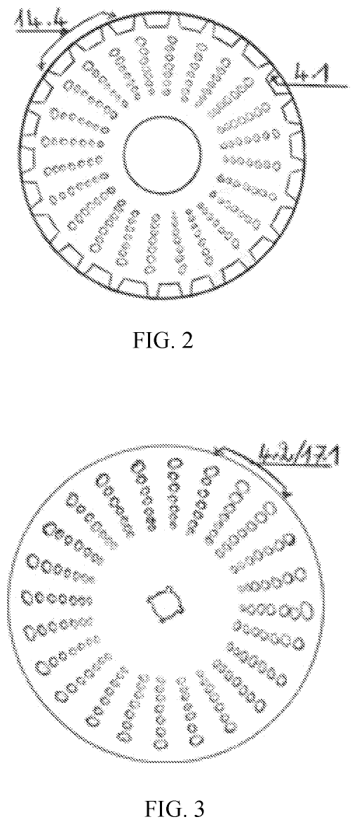

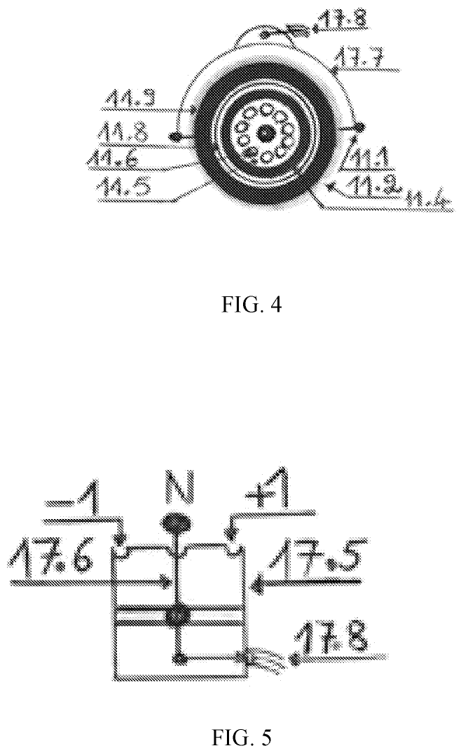

1: cone.

1.1: coaxial output.

2.1: source (of expulsion or backflow, depending on the sense of direction).

4: hermetic frame.

4.1: teeth.

4.2: translative pulse disc (perforated with curved holes)

4.3: cone.

8: compression valve.

9.1: source (of expulsion or backflow, depending on the sense of direction).

10: cover.

10.1: nut.

11.1: ball joint (articulation).

11.2: permanent magnet holder.

11.4: permanent magnet (multipolar radial type).

11.5: permanent magnet holder.

11.6: holes (to release the pressure).

11.7: backward sense of direction.

11.8: hermetic box.

11.9: two permanent magnets (multipolar radial type).

11.10: output.

13: threaded axis of rotation.

14: pressure relief valve.

14.1: ring.

14.2: rings.

14.3: compressed air reflux output.

14.4: toothed disc (perforated with straight holes).

14.5: compressed air reflux output.

17.1: translative pulse disc (perforated with curved holes).

17.2: nut.

17.3: ball bearing.

17.4: linear bearing.

19: cover.

23: forward sense of direction.

FIG. 2 is an illustration of a toothed disc perforated with straight holes.

4.1: teeth.

14.4: toothed disc (perforated with straight holes and the space between the teeth allows the backflow of compressed air).

FIG. 3 is the illustration of a double translative pulse disc perforated with curved holes.

4.2: translative pulse disc (perforated with curved holes).

17.1: translative pulse disc (perforated with curved holes).

FIG. 4 is an illustration of a magnetic mechanism.

11.1: ball joint.

11.2: permanent magnet holder.

11.4: permanent magnet (multipolar radial type).

11.5: permanent magnet holder.

11.6: holes (to release the pressure).

11.8: hermetic box.

11.9: two permanent magnets (multipolar radial type).

17.7: change means (linked to (17.6), allows the back and forth movement of the magnet holder

(11.2)).

17.8: transmission cable.

FIG. 5 is an illustration of a reversal box.

−1: position of (17.6), (backward sense of direction (11.7)).

+1: position of (17.6), (forward sense of direction (23)).

17.5: reversal box.

17.6: reversal lever.

17.8: transmission cable.

N: neutral (zero thrust).

### DETAILED DESCRIPTION OF THE EMBODIMENTS

A reverse directional thrust device by bidirectional translative movement, formed by a drive motor (M), one of the two coaxial outputs (1.1) of which meshes with the axis of this drive motor (M), maintaining a bidirectional translative movement, or the coaxial output (1.1), is applied by a coupling softener to the axis of the drive motor (M), a magnetic reversal mechanism composed of a permanent magnet holder (11.5), fixed to the output (11.10), and perforated with holes (11.6), to release the pressure, of which the permanent magnet (11.4), multipolar of the radial type, approaches along the internal surface of the hermetic box (11.8), this permanent magnet (11.4) is opposed by the same repulsive magnetic identity to two other permanent magnets (11.9), multipolar of the radial type to which it is adjoining, these permanent magnets (11.9), carried by another holder of permanent magnets (11.2), are positioned along the circumference of the hermetic box (11.8), their permanent magnet holder (11.2), having a ball joint (11.1), (on each side), moves in bidirectional translative movement by a change means (FIG. 4), (17.7), linked to the reversal lever (FIG. 5), (17.6), of the reversal box (FIG. 5), (17.5) by a transmission cable (FIG. 4), (FIG. 5), (17.8), this reversal lever (17.6), has three positions (+1), (N), (−1), respectively (forward sense of direction (23), neutral (N), backward sense of direction (11.7)), and finally, a system within a hermetic frame (4), comprising compressed air, two coaxial outputs (1.1), and (11.10), two compressed air reflux outputs (14.3) and (14.5), two covers (19) and (10), a compression valve (8), a pressure relief valve (14), two cones (1) and (4.3), two sources (2.1) and (9.1), each one can be of expulsion and of backflow, at least one expulsion set (4.2), (14.4), and (17.1), namely, a toothed disc (14.4), perforated with straight holes, teeth (4.1), this toothed disc (14.4), fixed to the hermetic frame (4), by rings (14.2), is interposed between two translative pulse discs, (17.1) and (4.2), perforated with curved holes and interposed by ring (14.1), these translative pulse discs (17.1) and (4.2), are fixed by nuts (10.1) and (17.2), and keys to the threaded axis of rotation (13), the linear bearings (17.4), (on each side) of the threaded axis of rotation (13), supporting the coaxial outputs, allow a bidirectional translative movement to this threaded axis of rotation (13), two other ball bearings (17.3) (on each side) of the threaded axis of rotation (13), having internal diameters greater than those of the coaxial outputs, limit by their internal rings, this movement of said threaded axis of rotation (13), characterized in that the two translative pulse discs (4.2), and (17.1), interposing the toothed disc (14.4), activate a thrust towards a sense of direction and allow to reverse this thrust towards the opposite sense of direction by repulsive interaction of two permanent magnets (11.9), linearly moving a permanent magnet (11.4), and at the same time the threaded axis of rotation (13), the latter drives one or the other translative pulse disc (4.2), or (17.1), at the limit of friction with the face exposed to it by the toothed disc (14.4), and this by means of the reversal lever (FIG. 5), (17.6), in position from (−1) repositioned to (+1) or in position form (+1) repositioned to (−1), subject to a relaxation of the meshing between the drive motor axis (M) and the coaxial output (1.1).

However, and despite the motor drive (M), the system provides a coupling softener within a hermetic box between the cover (19) and the drive motor (M), by linear bearings housed in a thick disc carried by the output of the drive motor shaft (M), these linear bearings independently support shafts attached to another thick disc carried by the output (1.1) of the threaded axis of rotation (13). This application by the coupling softener allows rapid repositioning and ensures reverse reliability, as the rotating components of the system keep the same direction of rotation. (Drive motor (M), coupling softener and magnetic reversing mechanism are not within the scope of the present invention).
A reverse directional thrust device by bidirectional translative movement, the thrust production of which is dependent on the displacement of the threaded axis of rotation (13), the latter must have a bidirectional translative movement to bring closer one or the other translative pulse disc (4.2), or (17.1), at the limit of friction with the face which exposes the toothed disc (14.4) to it, and to sequentially superimpose the holes of one of the translative pulse discs (4.2) or (17.1), to those of the toothed disc (14.4), to produce pulses by expulsion of compressed air through the holes of one face or of the other face of this toothed disc (14.4).

The pulse as an action repels the toothed disc (14.4), as a reaction.
A reverse directional thrust device by bidirectional translative movement, the system of which functions as a balance which instantly rebalances the pressure, either between the source (2.1), as an expulsion and the source (9.1), as a backflow, to produce a thrust towards the sense of direction (23), and this, by bringing the translative pulse disc (4.2) closer to the limit of friction with the face which exposes the toothed disc (14.4) to it, either, between the source (9.1), as an expulsion and the source (2.1) as a backflow, to produce a thrust towards the other sense of direction (11.7), and this by bringing the translative pulse disc closer together (17.1), at the limit of friction with the other face which exposes the toothed disc (14.4) to it.
The use of reverse directional thrust device by bidirectional translative movement, formed by a drive motor (M), one of the two coaxial output (1.1) of which meshes with the axis of this drive motor (M), maintaining a bidirectional translative movement or, the coaxial output (1.1), is applied by a coupling softener to the axis of the drive motor (M), a magnetic reversal mechanism composed of a permanent magnet holder (11.5), fixed to the output (11.10), and perforated with holes (11.6), to release the pressure, of which the permanent magnet (11.4), multipolar of the radial type approaches along the internal surface of the hermetic box (11.8), this permanent magnet (11.4), is opposed by the same repulsive magnetic identity to two other permanent magnets (11.9), multipolar of the radial type to which it is adjoining, these permanent magnets (11.9, carried by another permanent magnet holder (11.2), are positioned along the circumference of the hermetic box (11.8), their permanent magnet holder (11.2), having a ball joint (11.1), (on each side), moves in bidirectional translative movement by a change means (FIG. 4), (17.7), linked to the reversal lever (FIG. 5), (17.6), of the reversal box (FIG. 5), (17.5), by a transmission cable (FIG. 4), (FIG. 5), (17.8), this reversal lever (17.6), has three positions (+1), (N), (−1), respectively (forward sense of direction (23), neutral (N), backward sense of direction (11.7)), and finally, a system within a hermetic frame (4), comprising compressed air, two coaxial outputs (1.1), and (11.10), two compressed air reflux outputs (14.3) and (14.5), two covers (19), and (10), a compression valve (8), a pressure relief valve (14), two cones (1) and (4.3), two sources (2.1) and (9.1), each one can be of expulsion and of backflow, at least one expulsion set (4.2), (14.4), and (17.1), namely, a toothed disc (14.4), perforated with straight holes, teeth (4.1), this toothed disc (14.4), fixed to the hermetic frame (4), by rings (14.2), is interposed between two translative pulse discs (17.1) and (4.2), perforated with curved holes and interposed by ring (14.1), these translative pulse discs (17.1) and (4.2), are fixed by nuts (10.1) and (17.2), and keys to the threaded axis of rotation (13), the linear bearings (17.4), (on each side) of the threaded axis of rotation (13), supporting the coaxial outputs, allow bidirectional translative movement to this threaded axis of rotation (13), two other ball bearings (17.3) (on each side) of the threaded axis of rotation (13), having internal diameters greater than those of the coaxial outputs, limit by their internal rings, this movement of said threaded axis of rotation (13), characterized in that the reverse directional thrust device by bidirectional translative movement, ensures to a rolling vehicle, to a navigable vehicle, to an aerospace vehicle, or to other vehicle to which the said device may be applied, the means of having a thrust, a reverse thrust and a reversal of the sense of direction.

Thus, the invention presents a reverse directional thrust device by bidirectional translative movement, allowing movement by simple functions. However, the simplest function is the result of all the complications.

According to the present invention, the reverse directional thrust device by bidirectional translative movement can be presented in various modes of structure (embodiments, combinations or arrangements). However, the invention keeps the same features characteristics mentioned by the reverse directional thrust device by bidirectional translative movement.

Certainly, persons skilled in the art have the skills required for producing a thrust device with reverse directional thrust device by bidirectional translative movement, without departing from the scope of the present invention.

What is claimed is:

1. A reverse directional thrust device by a bidirectional translative movement, wherein
the bidirectional translative movement is formed by a drive motor,
one of two coaxial outputs of the reverse directional thrust device meshes with an axis of the drive motor maintaining the bidirectional translative movement, or the one of the two coaxial outputs is applied by a coupling softener to the axis of the drive motor,
a magnetic reversal mechanism composed of a first permanent magnet holder is fixed to an output, and the magnetic reversal mechanism is configured to be perforated with holes to release a pressure of a first permanent magnet, a multipole of the a radial type approaches along an internal surface of a hermetic box,
the first permanent magnet is opposed by an identical repulsive magnetic identity to two second permanent magnets to adjoin to the multipole of the radial type,
the two second permanent magnets, carried by another magnet gate, are positioned along a circumference of the hermetic box,
a second permanent magnet holder of the second permanent magnets, having a ball joint, on each side, moves in the bidirectional translative movement by a change means linked to a reversal lever of a reversal box by a transmission cable,
the reversal lever has three positions (+1), (N), (−1), respectively, wherein (+1) is a forward sense of direction, (N) is neutral, and (−1) is a backward sense of direction,
a system within a hermetic frame comprises
a compressed air,
the two coaxial outputs,
two compressed air reflux outputs,
two covers,
a compression valve,
a pressure relief valve,
two cones,
two sources, wherein each of the two sources is of an expulsion and of a backflow, and
at least one expulsion set, comprising a toothed disc, perforated with straight holes, and teeth,
wherein the toothed disc is fixed to the hermetic frame by rings and the toothed disc is interposed between two translative pulse discs perforated with curved holes and interposed by a ring,
the two translative pulse discs are fixed by nuts, and keys to a threaded axis of rotation,
linear bearings on each side of the threaded axis of rotation support the two coaxial outputs to allow the bidirectional translative movement to the threaded axis of rotation,
two ball bearings on each side of the threaded axis of rotation have internal diameters greater than internal diameters of the two coaxial outputs limit by internal rings of the two coaxial outputs,
wherein in the bidirectional translative movement of the threaded axis of rotation, the two translative pulse discs interposes the toothed disc to activate a thrust towards a sense of direction and to allow to reverse the thrust towards an opposite sense of direction by a repulsive interaction of the two second permanent magnets, linearly moving the first permanent magnet and at a same time the threaded axis of rotation, the threaded axis of rotation drives a first translative pulse disc or a second translative pulse disc at a limit of friction with a first face, wherein the first face is exposed to the first translative pulse disc or the second translative pulse disc by the toothed disc and by the reversal lever, wherein the reversal lever is in position from (−1) repositioned to (+1) or in position form (+1) repositioned to (−1).

2. The reverse directional thrust device according to claim 1, wherein the thrust is dependent on a displacement of the threaded axis of rotation, wherein the displacement of the threaded axis of rotation have the bidirectional translative movement to bring the first translative pulse disc or the second translative pulse disc closer to the limit of friction with the first face exposing the toothed disc to the first translative pulse disc or the second translative pulse disc, and to sequentially superimpose holes of one of the two translative pulse discs on holes of the toothed disc to produce pulses by the expulsion of the compressed air through holes of the first face or of a second face of the toothed disc.

3. The reverse directional thrust device according to claim 2, wherein the system operates as a balance instantly rebalancing the pressure either between a first source of the two sources as the expulsion and a second source of the two sources as the backflow to produce the thrust towards the sense of direction, wherein by bringing the first translative pulse disc or the second translative pulse disc closer to the limit of the friction with the first face, wherein the first face exposes the toothed disc to the first translative pulse disc or the second translative pulse disc, either between the second source as the expulsion and the first source as the backflow to produce the thrust towards opposite sense of direction, and by bringing the first translative pulse disc or the second translative pulse disc closer to the limit of friction with a second face, wherein the second face exposes the toothed disc to the first translative pulse disc or the second translative pulse disc.

4. A method of using a reverse directional thrust device by a bidirectional translative movement, wherein
the bidirectional translative movement is formed by a drive motor,
one of two coaxial outputs of the reverse directional thrust device meshes with an axis of the drive motor maintaining the bidirectional translative movement or the one of the two coaxial output is applied by a coupling softener to the axis of the drive motor,
a magnetic reversal mechanism composed of a first permanent magnet holder is fixed to the two coaxial outputs, and the magnetic reversal mechanism is configured to be perforated with holes to release a pressure of a first permanent magnet, a multipole of a radial type approaches along an internal surface of a hermetic box,
the first permanent magnet is opposed by an identical repulsive magnetic identity to two second permanent magnets to adjoin the multipole of the radial type to,
the two second permanent magnets carried by a second permanent magnet holder of the two second permanent magnets are positioned along a circumference of the hermetic box,
the second permanent magnet holder of the permanent magnets having a ball joint, on each side, moves in the bidirectional translative movement by a change means linked to a reversal lever of a reversal box by a transmission cable,
the reversal lever has three positions (+1), (N), (−1), respectively, wherein (+1) is a forward sense of direction, (N) is neutral, and (−1) is a backward sense of direction,
a system within a hermetic frame, comprises
a compressed air,
two coaxial outputs,
two compressed air reflux outputs,
two covers,
a compression valve,
a pressure relief valve,
two cones,
two sources, wherein each of the two sources is of an expulsion and of a backflow, and
at least one expulsion set, comprising a toothed disc, perforated with straight holes, teeth,
wherein the toothed disc is fixed to the hermetic frame by rings and interposed between two translative pulse discs perforated with curved holes and interposed by a ring,
the two translative pulse discs are fixed by nuts, and keys to a threaded axis of rotation,
linear bearings on each side of the threaded axis of rotation support the two coaxial outputs and allow the bidirectional translative movement to the threaded axis of rotation,
two ball bearings on each side of the threaded axis of rotation, have internal diameters greater than internal diameters of the two coaxial outputs, limit by internal rings of the two other ball bearings,
wherein in the bidirectional translative movement of the threaded axis of rotation, the reverse directional thrust device by the bidirectional translative movement ensures the reverse directional thrust device is applicable to a rolling vehicle, to a navigable vehicle, to an aerospace vehicle, or to other vehicle by having a thrust, a reverse thrust, and a reversal of the sense of direction.
